(19) United States
(12) Patent Application Publication
(10) Pub. No.: US 2016/0329719 A1
(43) Pub. Date: Nov. 10, 2016

(54) SOLAR POWER GENERATION SYSTEM

(71) Applicant: TENKSOLAR, INC., Minneapolis, MN (US)

(72) Inventors: Dallas W. Meyer, Prior Lake, MN (US); Chongfeng Zheng, Wuxi (CN); Juncheng Tan, Wuxi (CN); Qi Qui, Wuxi (CN)

(21) Appl. No.: 15/147,768

(22) Filed: May 5, 2016

(30) Foreign Application Priority Data
May 5, 2015 (CN) 201510224122.3

(51) Int. Cl. H02J 3/38; H02M 7/44

(52) U.S. Cl. CPC H02J 3/385; H02M 7/44

(57) ABSTRACT

In an example, a solar power generation system includes solar panels, DC optimizers, and inverters. The numbers of the solar panels and the DC optimizers are both N, and the number of the inverters is M. An output of each solar panel is connected to a DC optimizer. The DC optimizer is mainly used to track the maximum power point of the solar panel and stabilize the current, thereby maximizing the output power of the solar panel. Moreover, outputs of all DC optimizers are connected in parallel to construct a DC bus, inputs of the M inverters are connected in parallel, the M inverters whose inputs are connected in parallel extract current from the DC bus, and outputs of the M inverters are also connected in parallel to the same power grid. Advantages of safety, reliability and high power generation efficiency are implemented.

### CROSS-REFERENCE TO RELATED APPLICATIONS

This patent application claims priority to Chinese Patent Application No. 201510224122.3, filed May 5, 2015, which is incorporated herein by reference.

### TECHNICAL FIELD

The present disclosure relates to the field of solar power generation, and in particular, to a solar power generation system.

### BACKGROUND

Currently, as a clean energy, solar energy has been widely paid attention to all over the world. Large scale photovoltaic power stations have been established in Europe and America. The photovoltaic power generation is also flexible, and can be used at roofs of buildings, squares, or used to directly substitute external walls of buildings to establish small-sized power stations, which not only is beautiful, but also can effectively use the solar energy. Current solar power generation systems are classified into the following types, as shown in FIG. 1: solar panels are connected in series to be connected to a string formation type inverter. The solution shown in FIG. 1 has the advantage of low cost, only one high-power string formation type inverter is used to connect components to form the solar power generation system, so that the assembling is simple. However, the system also has obvious defects: because of the serial connection structure of the components, the single inverter cannot enable each solar panel to work in the maximum output power condition, the power generation amount is greatly influenced by shadow, shields and the like; moreover, all the components are connected in series, output voltage thereof is very high, and a potential risk to the safety of the system exists, so that an additional arc-control device is required to be disposed at the high-voltage DC side.

In a solution 2 of the conventional solar power generation system, as shown in FIG. 2, an optimizer is added to the system of the solution 1, and this solution solves the defect in the solution 1 that the single inverter cannot ensure that each solar panel works at the maximum power point. Each solar panel is connected to a DC optimizer to track the maximum power point of the solar panel, thereby maximizing the power generation of the solar system. The solution 2 is obviously advanced relative to the solution 1, but does not solve the safety problem brought by high-voltage DC current in the solution 1, and at the same time, the added DC optimizer also causes higher cost than the solution 1. The cost of the whole system is higher than that of the solution 1; however, by taking the added amount of generated power into consideration, this solution may have a better return on investment (ROI) than the conventional solution of directly connecting the solar panels to the string formation type inverter as in solution 1.

A solution 3 of the conventional solar power generation system, as shown in FIG. 3, is a solution getting increasingly more attention recently. Output of each solar panel is directly connected to a micro inverter, and the power generated by the solar panel is directly converted into AC and is connected to the grid for power generation. The micro inverter implements a maximum power tracking strategy, and can optimize the connected solar panel, thereby achieving outputting and running at the maximum power. The output voltage of a single solar panel is not higher than 50 volts (V); therefore, such a system is obviously advantageous in high safety compared with the solution 1 and the solution 2. For the solar power generation system, the ROI is on the basis of a fact that the power station can generate power in a long time stably and continuously, and if the power station is damaged or has accidents such as fire due to the safety problem, it is a very bad bargain. Therefore, in America and Europe, the solution 3 is increasingly paid attention to. Especially in America, regulations have been set primarily, and in the near future, the system voltage in the solar power generation system will be required to be in a safety range of lower than 80 V, so as to ensure that the solar power station can run safely and reliably in a long time. The solution 3 also has an obvious defect: because each solar panel is connected to an inverter, and each inverter includes a boosted circuit, an inverter circuit and a control method such as maximum power tracking required by the conventional inverter, the micro inverter solution has the highest cost of the three solutions 1-3 described above.

In view of the above, the conventional solar power generation systems have respective advantages and defects, and there is not a solar power generation system being cheap, safe and reliable, and having large power generation amount.

### SUMMARY

An objective of the present disclosure is to, with regard to the above problems, provide a solar power generation system to implement advantages of safety, reliability, and high power generation efficiency.

To implement the above objective, the present application uses the following technical solution:

A solar power generation system according to at least one embodiment includes solar panels, DC optimizers, and inverters. A number of the solar panels and a number of the DC optimizers are both N, and a number of the inverters is M. An output of each solar panel is connected to a DC optimizer. The DC optimizer may be configured to track the maximum power point of the corresponding solar panel and stabilize the current, which in some embodiments may maximize the output power of the corresponding solar panel. Moreover, outputs of all DC optimizers are connected in parallel to construct a DC bus, inputs of the M inverters are connected in parallel, the M inverters whose inputs are connected in parallel extract current from the DC bus, and outputs of the M inverters are also connected in parallel to the same power grid.

In some embodiments, the DC optimizer is integrated in a solar panel junction box or is connected to the solar panel as an independent external device, the DC optimizer integrates communication, and the input power of the DC optimizer is adjusted through remote communication.

Preferably, the inverter is controlled by using self-current-sharing control and redundancy control. In the self-current-sharing control, total output power that can be provided by the DC bus is Pmax, the M inverters are connected in parallel and extract current from the DC bus, and the power processed by each inverter is Pinverter=Pmax/M. In the redundancy control, a working point Vsetpoint of each inverter is set, output currents of the N DC optimizers are added to start to charge the DC bus, after the voltage of the DC bus is boosted to a working point of one of the inverters, the inverter starts to convert energy and output power, after there is energy flowing toward the power grid, the voltage of the DC bus is drawn down, and in this point, there are two cases. One case is that the power provided by the DC optimizer is greater than the power that can be output by the inverter, the voltage of the DC bus may be continuously boosted, and when the voltage reaches to a working point of another inverter, the second inverter starts to output power, that is, starts to extract the current of the DC bus, if the power of the DC bus is still greater than the sum of the output powers of the two inverters, a third inverter starts to work, and the process repeats until the power provided by the DC bus is less than the power output by a working inverter, and in this case, the inverters working firstly work in the highest conversion efficiency condition, and the last inverter works at the proper power. The other case is that when the power provided by the DC bus is less than the power of the inverter, only one inverter works, and other inverters are in a standby state; the multiple inverters may be set to have the same working point, the multiple inverters having the same working point are set to work together, and when the multiple inverters having the same working point work together, the multiple inverters enable the self-current-sharing control.

In some embodiments, a number of the inverters is M+1, that is, one more inverter is configured according to the case of full power.

In some embodiments, the DC bus is electrically connected to a low-voltage DC device to provide energy for the low-voltage DC device to run.

In some embodiments, the DC bus is connected to a storage battery, and the inverter is compatible with a management control strategy of the storage battery, specifically: when the storage battery is run out, the DC optimizer tracks the maximum power of the solar panel, and outputs power to the low-voltage DC bus, in this case, the battery level of the storage battery is low, the current on the DC bus preferentially charges the storage battery, until the voltage of the DC bus is boosted to the working voltage of the inverter, the inverter starts to work, the inverter sends redundant power on the DC bus to the power grid, and when it is necessary to discharge the storage battery, the storage battery is discharged by adjusting the working voltage of the inverter to be less than the output voltage of the storage battery, and the working voltage of the inverter cannot be lower than the safety voltage of the storage battery in order to protect the storage battery;

Moreover, to compensate the insufficient energy of the storage battery on the DC bus, a rectifier for converting AC into low-voltage DC is externally connected to the DC bus, and the rectifier for converting AC into low-voltage DC charges the storage battery when the energy on the DC bus is insufficient.

In some embodiments, the solar power generation system further includes an off-grid inverter and a switching switch, wherein when the power grid fails, the switching switch is used to cut off the power supply of the power grid to an internal load, and only the off-grid inverter is used to supply power to the internal load, thereby achieving the function of emergency power supply.

In some embodiments, the number M of the inverters is any number between 1 and N, and a ratio of DC power to AC power is adjusted according to a ratio of M and N.

In some embodiments, each solar panel includes a polycrystalline solar panel, a monocrystalline solar panel, or a thin-film solar panel.

In some embodiments, the inverter includes a micro inverter or a low-input voltage grid-connected inverter. In some embodiments, micro inverters may include rack mounted inverter units and/or 0.5 to 2 kilowatt (kW) inverter units that may be potted in some embodiments. Alternatively or additionally, low-input voltage grid-connected inverters may include wall-mounted or under-solar-panel-array-mounted inverter units and/or 2 to 10 kW inverter units with open air flow or forced air flow for cooling. Micro inverters and/or low-input voltage grid-connected inverters may accept a DC input of 60 volts or more or less than 60 volts in some embodiments.

In some embodiments, the micro inverter has single-path input, two-path input or multi-path input, and the low-input voltage grid-connected inverter has single-path input, two-path input or multi-path input.

The technical solution of the present disclosure may have the following beneficial effects:

In the present disclosure, all outputs of the DC optimizers may be connected in parallel, and may share the same DC bus, thereby avoiding the high voltage in the conventional string formation solution, and there is only low voltage existing in the system; therefore, the system does not need to consider the safety problem in the high-voltage system, and may avoid use of a protection device such as an arc-control device and a DC circuit breaker. The self-current-sharing control and redundancy control may be used, so as to prolong the service life of the solar power generation system and improve the conversion efficiency of the whole system. The objectives of safety, reliability and high power generation efficiency may be implemented. The storage battery and the off-grid inverter may further enhance the flexibility of the system. Because of the existence of the DC bus and the storage battery, a low-voltage DC load may be directly powered, and if the storage battery is running out, a rectifier for converting AC to DC may be used directly to charge the low-voltage storage battery.

The technical solution of the present disclosure is further described in detail through accompanying drawings and embodiments.

### DESCRIPTION OF THE DRAWINGS

FIG. 1 is a schematic diagram of an existing solar power generation system in which solar panels are connected in series to a string formation type inverter;

FIG. 2 is a schematic diagram of an existing solar power generation system in which solar panels and optimizers are connected to a conventional string formation type inverter;

FIG. 3 is a schematic diagram of an existing solar power generation system in which solar panels are connected to micro inverters;

FIG. 4a to FIG. 4c are schematic diagrams of a solar power generation system according to an embodiment of the present disclosure;

FIG. 5a is a schematic diagram of a load current flowing direction of an existing optimizer;

FIG. 5b is a schematic diagram of a load current flowing direction of an existing optimizer when it is failed;

FIG. 6a is a schematic diagram of a load current flowing direction when outputs of DC optimizers in a solar power generation system according to an embodiment of the present disclosure are connected in parallel;

FIG. 6b is a schematic diagram of a load current flowing direction during failure when outputs of DC optimizers in a solar power generation system according to an embodiment of the present disclosure are connected in parallel;

FIG. 7 is a schematic diagram of micro inverters having inputs connected in parallel to a DC bus according to an embodiment of the present disclosure;

FIG. 8 is a schematic diagram of a current flowing direction when micro inverters having inputs connected in parallel use a current-sharing control algorithm according to an embodiment of the present disclosure;

FIG. 9 is a schematic diagram of a current flowing direction of a redundancy control solution of micro inverters according to an embodiment of the present disclosure;

FIG. 10 and FIG. 11 are schematic diagrams of redundancy control features of micro inverters according to an embodiment of the present disclosure;

FIG. 12 is a schematic diagram of a solar power generation system connected to a storage battery according to an embodiment of the present disclosure;

FIG. 13a to FIG. 13c are schematic diagrams of a solar power generation system connected to a low-voltage DC device according to an embodiment of the present disclosure;

FIG. 14 and FIG. 15 are schematic diagrams of a solar power generation system constructed by using low-voltage input grid-connected inverters according to an embodiment of the present disclosure; and

FIG. 16a to FIG. 16c are schematic diagrams of a solar power generation system constructed by using low-voltage input grid-connected inverters and connected to a low-voltage DC device according to an embodiment of the present disclosure.

### DETAILED DESCRIPTION

Preferred embodiments of the present invention are described through the accompanying drawings, and it should be understood that, the described preferred embodiments are merely used to illustrate and explain the present invention, and are not intended to limit the present invention.

In this embodiment, a micro inverter is used as an example for specific description.

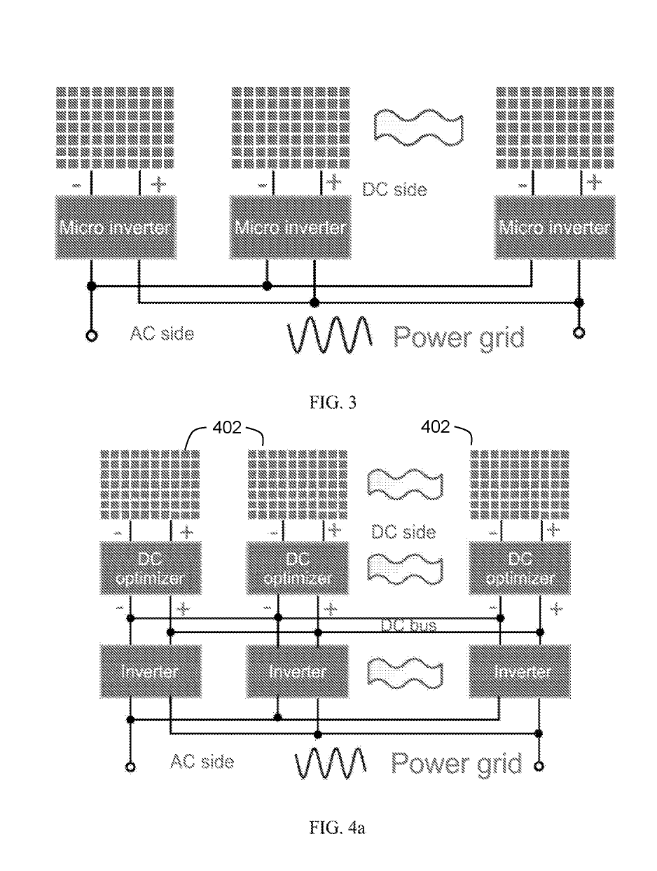

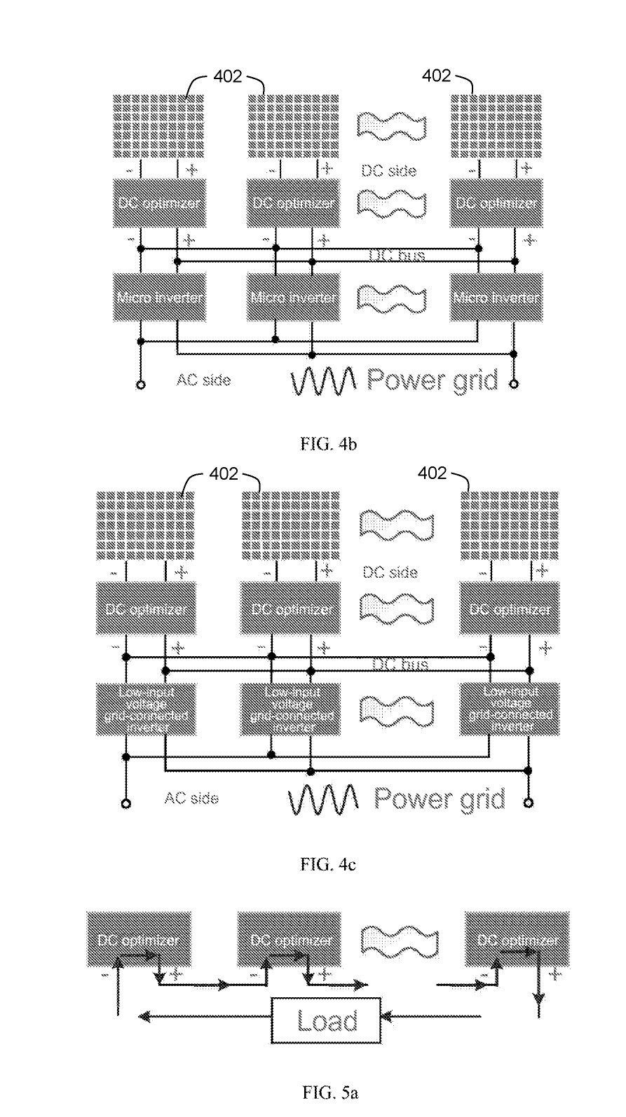

As shown in FIG. 4b, in a solar power generation system, output of each solar panel 402 is connected to a DC optimizer, and a main function of each DC optimizer may be tracking the maximum power point of the corresponding solar panel 402, thereby maximizing the output power of the corresponding solar panel 402. The method of connecting the outputs of the DC optimizers is different from the serial connection method in the solution 2 (see FIG. 2); instead, the outputs of all the DC optimizers in FIG. 4b are connected in parallel, so as to construct a DC bus. The voltage of the DC bus is not greater than 80V. Micro inverters are used to convert DC to AC. Likewise, inputs of all the micro inverters are connected in parallel, and outputs of the micro inverters are connected in parallel to the same power grid, so as to convert the DC current generated by the solar energy into AC current for grid-connected power generation. Because of the existence of the DC optimizers, the micro inverters are not directly connected to the solar panels 402, and therefore, the maximum power tracking control is not needed in the micro inverters. The DC bus constructed in the technical solution of the present disclosure is a low-voltage DC bus.

FIG. 4a and FIG. 4c each includes an analogous configuration as FIG. 4b, except that FIG. 4a generically includes inverters instead of micro inverters, and FIG. 4c includes low-input voltage grid-connected inverters instead of micro inverters. The inverters of FIG. 4a may include micro inverters or low-input voltage grid-connected inverters or any suitable type of inverter. As used herein, “inverter” by itself may generically refer to micro inverters or low-input voltage grid-connected inverters or other type of inverters.

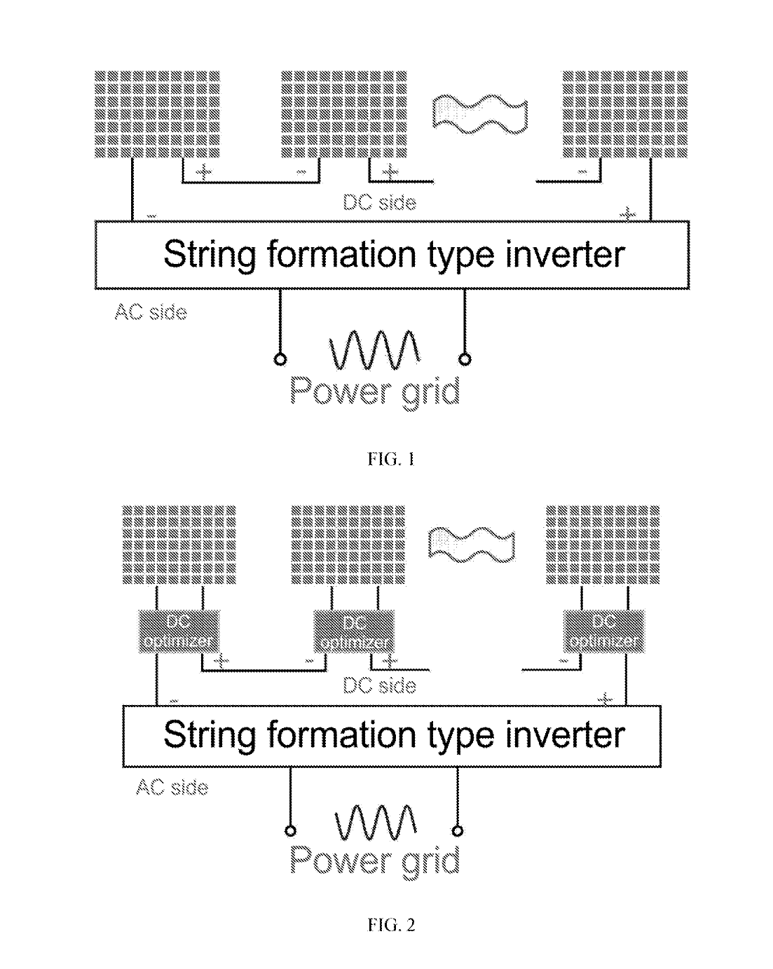

The range of the output voltage of each of the solar panels 402 in these and other embodiments described herein may be 22V-55V, and the output voltage of each DC optimizer may be less than 60V. The connection manner shown in FIG. 4b may avoid the high voltage in the serial connection solution shown in FIG. 1, and there is only low voltage existing in the system; therefore, the system does not need to consider the safety problem in the high-voltage system, and avoids use of protection devices such as an arc-control device and a DC circuit breaker.

Each of the DC optimizers may be integrated in a corresponding solar panel junction box or may be connected to the corresponding solar panel 402 as an independent external device or may otherwise be connected to the corresponding solar panel 402. Each DC optimizer may integrate communication, and the input power of each DC optimizer may be adjusted through communication (such as WIFI, GRPS, RF, 3G or 4G). For the solar power generation system, the power may be controlled by a remote control (such as WIFI, GPRS, RF, power line carrier, 3G or 4G) communication manner, and the output of each DC optimizer may be monitored, thereby further adjusting the power output of the system. For example, each DC optimizer or micro inverter may be controlled separately. Each micro inverter may be single-path input, and may also be two-path or multi-path input.

FIG. 4a is a solar power generation system implemented by inverters, FIG. 4b is a solar power generation system implemented by micro inverters, and FIG. 4c is a solar power generation system implemented by low-input voltage grid-connected inverters.

As shown in FIG. 5a, for some existing DC optimizer connection configurations (see FIG. 2), a total load current may flow through each DC optimizer in series. After one of the DC optimizers is failed, the current needs to be bypassed by using, e.g., a bypass diode, so as to prevent the current from flowing through the damaged DC optimizer to generate heat continuously to cause a fire. Even if such a bypass diode is used as illustrated in FIG. 5b, in a full load condition, a large load current may flow through the bypass diode to generate loss and further generate heat, and the continuous heat generation may cause a potential risk of fire. In FIG. 5b and other figures herein, the failed DC optimizer or other failed device or component may be denoted by an X through a negative (“−” in the figures) and a positive (“+” in the figures) output or input of the failed DC optimizer or other failed device or component. The same drawing convention (e.g., X through a negative and a positive output or input) may be used to denote devices or components that are in a standby state (e.g., capable of operation but not currently operating), whether or not the devices or components have failed.

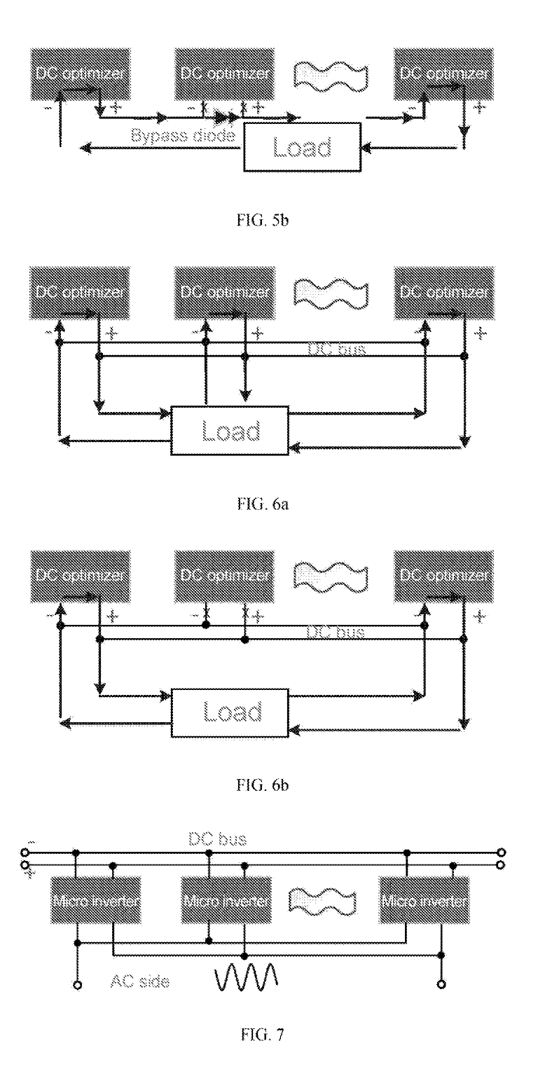

In the manner of constructing the DC bus by connecting the outputs of the DC optimizers in parallel in the technical solution of the present disclosure, the load current will not flow through all the DC optimizers. As shown in FIG. 6a (which may include the DC optimizers of FIGS. 4a-4c), in this case, the load current is obtained by overlapping output current of all the DC optimizers. After one of the DC optimizers is failed, the failed DC optimizer no longer provides the load current, and a fuse of the output of the DC optimizer can effectively block flowing of other load current, thereby preventing the current from flowing through the damaged DC optimizer to generate heat. Therefore, the reliability of the system is further improved. For example, as illustrated in FIG. 6b (which may include the DC optimizers of FIGS. 4a-4c), load current does not have to flow through a failed DC optimizer or a corresponding bypass diode as in the example of FIG. 5b since outputs of the DC optimizers are coupled in parallel in the example of FIG. 6b.

After the DC bus is constructed, a new characteristic is brought for the micro inverter at the rear end thereof. The input voltage of the string formation type inverter such as may be implemented in solutions 1 and 2 described above (see FIGS. 1 and 2) must be higher than 200V, and therefore, the existing methods include connecting the outputs of the DC optimizers in series (see FIG. 2) or directly connecting the solar panels in series (see FIG. 1) to obtain the high voltage. However, the voltage of the DC bus constructed by connecting the outputs of the DC optimizers in parallel as described herein is very low, and is generally less than 60V, which is just applicable to the input condition of the micro inverter. However, when outputs of multiple micro inverters are connected in parallel, there is a problem of how to optimize the distribution of an energy flow.

In combination with the solution of constructing the DC bus by using the DC optimizers in the present disclosure, the present disclosure provides a solution to solve the problem of optimizing the distribution of the energy flow: that is, low-voltage inputs of the micro inverters are connected in parallel, and are all connected to a uniform DC bus, as shown in FIG. 7. The micro inverters of FIG. 7 may include or correspond to the micro inverters of FIG. 4b.

To increase the reliability of running of the system, a control strategy (or control manner) of the micro inverter is different from that of a regular micro inverter. The present disclosure provides two such control manners, referred to as control manner 1 and control manner 2:

In the control manner 1 of the micro inverter, the self-current-sharing control, total output power that can be provided by the DC bus constructed by the outputs of the DC optimizer is Pmax=Vdcbus*(I1+I2+ . . . +In), the M micro inverters are connected in parallel to the DC bus, and the power processed by each micro inverter is Pinverter=Pmax/M, aspects of which are depicted in FIG. 8. The self-current-sharing control is used, and therefore, each micro inverter works in the same working condition (the same input voltage, the same input current, the same output voltage-grid, and the same output current), and the whole system is in a very stable working condition. The same power condition represents the same heat, and it is a very excellent working condition for heat dissipation processing. For the existing manner of directly connecting the solar panels to the micro inverters as described with respect to solution 3 (see FIG. 3), different solar panels are subjected to different influences of the environment, process different powers, and have different heat dissipation conditions; therefore, the heat dissipation of the micro inverter can merely be considered uniformly according to the heat at the maximum power and the maximum loss.

Further, the maximum efficiency point of the electronic product such as the inverter is generally distributed at 60% to 80% of the full power, and averagely distributing the total power represents that the conversion efficiency of the system can be maintained near the highest point, and the conversion efficiency of the inverter is low in a full load condition and a light load condition. The self-current-sharing solution described herein can reduce the loss caused by heavy loads of some machines and light loads of other machines (a difference caused by power generation of different solar panels), thereby further improving the power generation amount of the system.

In the control manner 2 of the micro inverter, the redundancy control, a part of machines are enabled to work at working points of the highest conversion efficiency, and the rest machines are stopped, thereby reducing the loss and improving the overall reliability of running of the system. Every morning, each micro inverter is started and obtains a random working point (Vsetpoint) through an algorithm that can be implemented by using an existing algorithm, and extracts proper power (the power at the maximum efficiency) from the DC bus. Output currents of N DC optimizers are added to start to charge the DC bus. Once the voltage of the DC bus is boosted to the working point (the lowest voltage point relative to other inverters) of one micro inverter, the micro inverter starts to convert energy and output power. Once there is energy flowing to the power grid, the bus voltage is drawn down. In this point, there are two cases: one case is that the power provided by the DC optimizer is greater than the power that can be output by the micro inverter, the voltage of the DC bus will be continuously boosted, and when the voltage reaches a working point of another micro inverter, the second micro inverter starts to output power (extract the current of the DC bus), if the power of the DC bus is still greater than the sum of the output power of the two micro inverters, a third micro inverter starts to work, and the process repeats until the power provided by the DC bus is less than the power output by a running micro inverter, and in this case, the micro inverters working firstly work in the highest conversion efficiency condition, and the last micro inverter works at the proper power. In this case, Pinverter_1+Pinverter_2+ . . . +Pinverter_M=PDC is satisfied. That is, power from inverter 1 (Pinverter_1), plus power from inverter 2 (Pinverter_2), . . . plus power from invert M (Pinverter_M) equals power of the DC bus (PDC) in this case. Pinverter_1 to Pinverter_M−1 all work at the highest efficiency point, and only Pinverter_M does not work at the highest efficiency point, the rest micro inverters do not work, do not output power, and are in a standby state to reduce the loss, thereby improving the overall running reliability of the system. The second case is that, when the power provided by the DC bus is less than the power of the micro inverter, only one micro inverter works, and other micro inverters are in a standby state. The multiple micro inverters may be set to have the same working point, the multiple inverters having the same working point are set to work together, and when the multiple inverters having the same working point work together, the multiple inverters enable the self-current-sharing control.

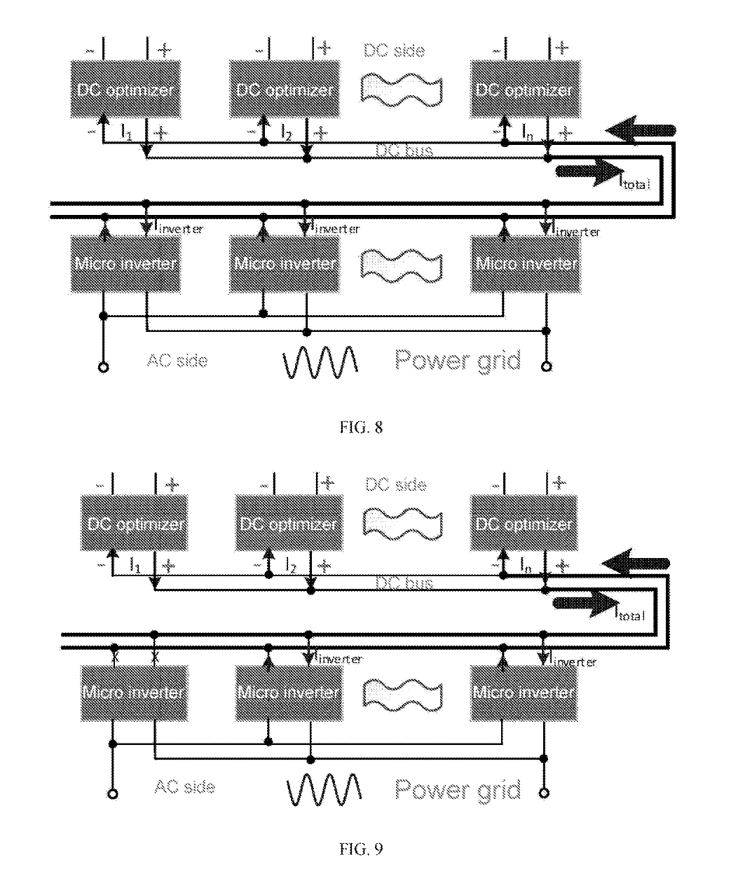

As shown in FIG. 9, in the redundancy control principle, the current merely flows through several inverters having low working points, and the rest inverters are still in the standby state. For example, in FIG. 9 the leftmost micro inverter may have a relatively higher working point than the two rightmost micro inverters and may be in a standby state, as denoted by an X through each of the positive and negative inputs of the leftmost micro inverter. In operation, when the sun rises every day, an obtained working point voltage for each of the inverters may be random, in other words, the inverter that works first every day is not fixed, and the standby inverters are not fixed. In this way, a part of inverters are rested and the power orientation is optimized, thereby prolonging the service life of the solar power generation system and improving the reliability of the whole system.

A specific example is described as follows.

For example, the solar power generation system of the present disclosure is formed by ten 250 W DC optimizers and ten 250 W micro inverters. The range of the output voltage of each DC optimizer is 36V to 50V. The input working voltage of each micro inverter is set to about 40V (if the voltage is less than 40V, the micro inverter will not output power). In the morning, after sunrise, each solar panel 402 is controlled by the corresponding DC optimizer to work at the maximum power point in this time, and outputs the maximum power 150 W. The total power output by the ten solar panels is 10×150 W=1500 W. The ten 250 W micro inverters randomly select own start voltages in the morning. It is assumed that, randomly, five inverters select 40V, three inverters select 40.1V, and the remaining two inverters select 40.2V. As the DC optimizers output current together, the voltage of the DC bus starts to rise, and when the voltage rises to 40V, the five micro inverters selecting the working point of 40V start to work and extract power from the DC bus, each inverter extracts 200 W (200 w/250 w=80%, the inverter has the highest efficiency when processing 80% of the power), and the five inverters totally process 1000 W power. The DC optimizers are connected in parallel, the provided power is greater than 1000 W, so that the voltage rises continuously. When the voltage of the DC bus rises to 40.1V, the three inverters setting their working points to 40.1V start to work to process the power. The sampling control manner 1 is the self-current-sharing control, and in this case, the output power of each micro inverter is (1500−1000)/3=166.67 W. The output power of the inverters and the power of the DC bus are balanced, the current on the DC bus is totally processed by the eight micro inverters, the voltage of the DC bus maintains at 40.1V (the five inverters whose working points are 40V maintain 200 W to run at the working point of 40.1V), the remaining two inverters select the working point of 40.2V, and because the voltage of the DC bus does not reach 40.2V, the two inverters are in a standby state and do not work.

As time goes by, the amount of light rises, and the power output by the solar panel also rises. When the output power of the solar panel reaches 200 W, the DC bus power output of the DC optimizers reaches 2000 W. As the power of the DC bus rises, the eight working micro inverters can only process 1600 W, the rest 400 W power will continuously boost the DC bus, until the voltage of the DC bus reaches 40.2V; in this case, the remaining two micro inverters work and start to process the power, extract the remaining 400 W power and connect to the power grid. Now, all the micro inverters participate in the power processing.

Further, as time goes by, at midday, the output power of the solar panel rises to 220 w, the power of the DC bus reaches 2200 W, and because the power of the DC bus is greater than the power that is processed by the inverters, the DC bus cannot maintain at 40.2V and is further boosted. If the micro inverter cannot extract more power, the voltage of the DC bus will rise continuously until the voltage of the DC bus is boosted to 41V. In this case, the five inverters selecting the working point of 40V switch their working points to 41V, and allow the output power to reach 250 W; the three inverters whose working points are 40.1V also switch to working points of 41.1V, and allow the output power to reach 250 W; and the rest two micro inverters also switch their working points to 41.2V. In this case, the power orientation is changed, the five inverters setting their working points at 41V each process 250 W power, and merely process 1250 W power in total; the voltage of the DC bus still cannot be maintained, the voltage rises continuously to 41.1V, the three inverters setting their working points at 41.1V start to work and output the power, and the processed power reaches 750 W (or 1250 W+750 W=2000 W total), but the total power is still lower than 2200 W, the remaining 200 W continuously boosts the voltage of the DC bus to 41.2V, and the last two micro inverters start to work and process the remaining 200 W power together. The forgoing self-current-sharing feature is taken into consideration. The working states of the ten micro inverters are: eight inverters work at the full load 250 W, and the rest two inverters work at 100 W.

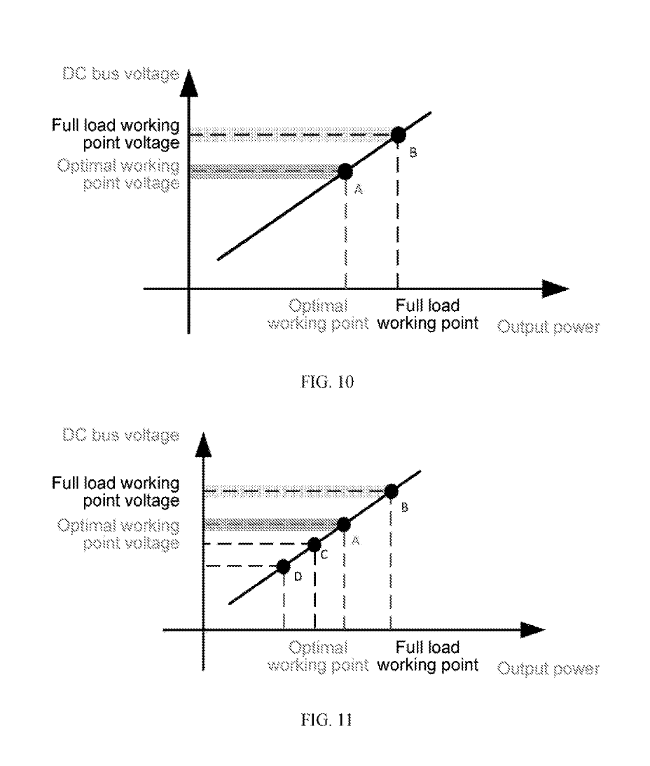

For the redundancy control manner, another advantage is backup. No micro inverter is connected to a fixed solar panel or fixed DC optimizer during work, and any solar panel failure or DC optimizer failure will not affect the micro inverter from working at the optimal point. Likewise, when the micro inverter is failed, normal working of other micro inverters will not be influenced as long as an input fuse is disconnected. To ensure that the system can run safely and reliably for a long time, (M+1) micro inverters may be configured in the system. In other words, one more micro inverter is configured according to the case of full power, which may greatly prolong the service life of the system. If an inverter is failed, it is only needed to replace the failed inverter. A self-adaptive feature of the redundancy control is shown in FIG. 10. In the drawing, there are two working points, one is an optimal working point A, and the other is a full load working point B. The micro inverter preferably works at the optimal working point, and only when the power provided by the DC bus is greater than the sum of optimal working point power of all micro inverters, the inverter is switched to the full load working point.

As shown in FIG. 10, the optimal working point and the full load working point are each a range (for example, 40V, 40.1V and 40.2V in the example), and the redundancy control of the micro inverter randomly selects a working point near a voltage, so that the micro inverter that first works every morning is not fixed, and the micro inverter working for the longest time every day is also not fixed, thereby improving the reliability and running life of the whole system. Further, the design of working points is not limited to the optimal working point A and the full load working point B, and may also set a less optimal working point C (FIG. 11), a further less optimal working point D (FIG. 11), and the like. As shown in FIG. 11, setting of multiple working points mainly aims to enable the whole system to have the highest power generation amount and use the inverters to convert energy in the highest efficiency and the longest lifetime under different light conditions.

The structure in which outputs of the DC optimizers are directly connected in parallel can still ensure that each micro inverter works at the optimal working point in a case that output power of each solar panel varies, which is different from the conventional solution 3 (see FIG. 3) in which the micro inverter can merely process the power of one solar panel. The solution of connecting the outputs of the optimizers in parallel and establishing the DC bus brings a lot of possibilities for optimization of the energy flow.

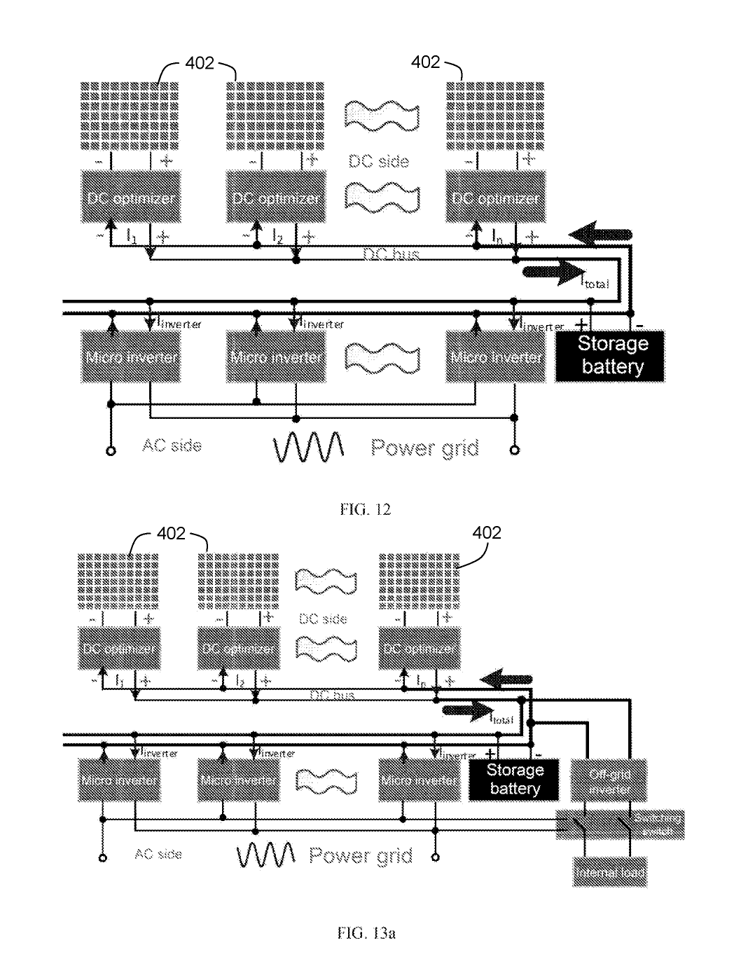

After the low-voltage DC bus is constructed, another advantage of the present disclosure is that it is compatible with an energy storage system, as shown in FIG. 12. Because of the low voltage feature of the DC bus, a storage battery of 36V or 48V (selected according to an optimization point selected by the redundancy control) is obtained by serially connecting regular 12V lead-acid batteries, the storage battery may be directly connected to the DC bus, and the micro inverters may be compatible with the storage battery management and control strategy. Whether each micro inverter works depends on the voltage of the DC bus, and therefore, each micro inverter may determine whether to connect to the grid for power generation according to a current value of the voltage of the DC bus. The specific control strategy is introduced as follows: when the storage battery is running out, each DC optimizer tracks the maximum power of the corresponding solar panel 402, and outputs power to the DC bus; in this case, the battery level of the storage battery is low, the voltage on the DC bus is low (by using a 36V storage battery as an example, the voltage is dropped to be lower than 30V), the current of the solar power generation system preferentially charges the storage battery, until the voltage of the DC bus is boosted to 40V, the micro inverter(s) with the lowest working point starts to work, and the micro inverter(s) is connected to the power grid and sends the redundant power of the solar power generation system to the power grid. When discharging of the storage battery is required, the storage battery may be discharged only by adjusting the working voltage of each micro inverter to be less than 36V through communication. To protect the storage battery, the working voltage of each micro inverter may be set to be greater than or equal to a safety voltage (or minimum voltage) of the storage battery.

The solar power generation system provided in the present disclosure can extend many applications after being combined with the storage battery. Existing solar power generation systems (see FIGS. 1-3) do not have a DC bus or only have a high-voltage DC bus. Such solar power generation systems without a DC bus do not have an energy storage function, and can only convert the electric energy generated by the solar energy into AC of the mains supply for grid-connected power generation, which cannot bring the maximum profit for a client. In many families, the electricity consumption is less in daytime while the power generated by the solar energy is more, and the electricity consumption is more at nights while there is no solar electric energy to use. The solution integrating the storage battery proposed in the present disclosure can solve the foregoing problem. The problems of the high-voltage DC bus are obvious, the storage battery can be mounted and replaced only by engineers having professional electrical qualifications, and potential risks to the safety of the high-voltage storage battery such as arcing and discharging exist, so an external safety device is needed for protection. If the high-voltage DC bus is used and the low-voltage storage battery is also used, a new DC-to-DC converter is required to be connected between the DC bus and the battery to convert the electric energy. Moreover, the storage battery needs to consider charging and discharging. Generally, two DC converters are selected, one converts high voltage to low voltage for energy storage, and the other converts low voltage to high voltage for energy discharging; or, a two-way DC converter is used. The use of two DC converters or a two-way DC converter both increase the complexity of the system. The additional DC converter(s) also generates energy loss during charging and discharging, thereby reducing the efficiency of the whole system.

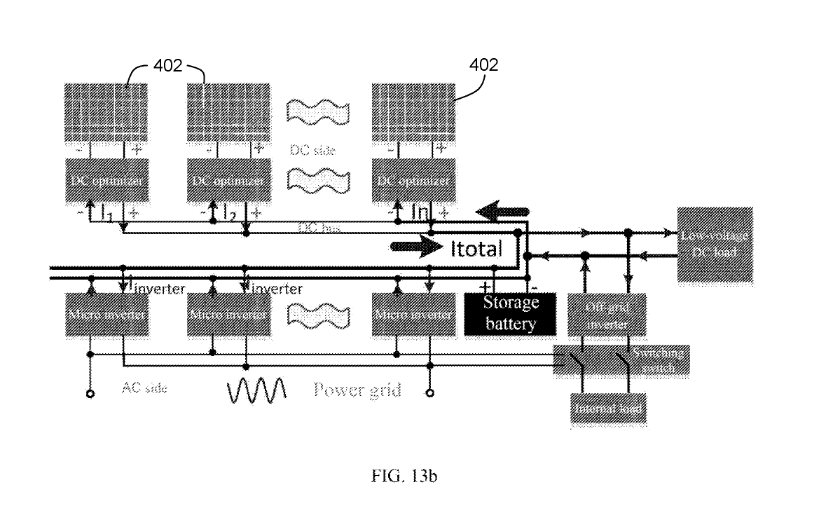

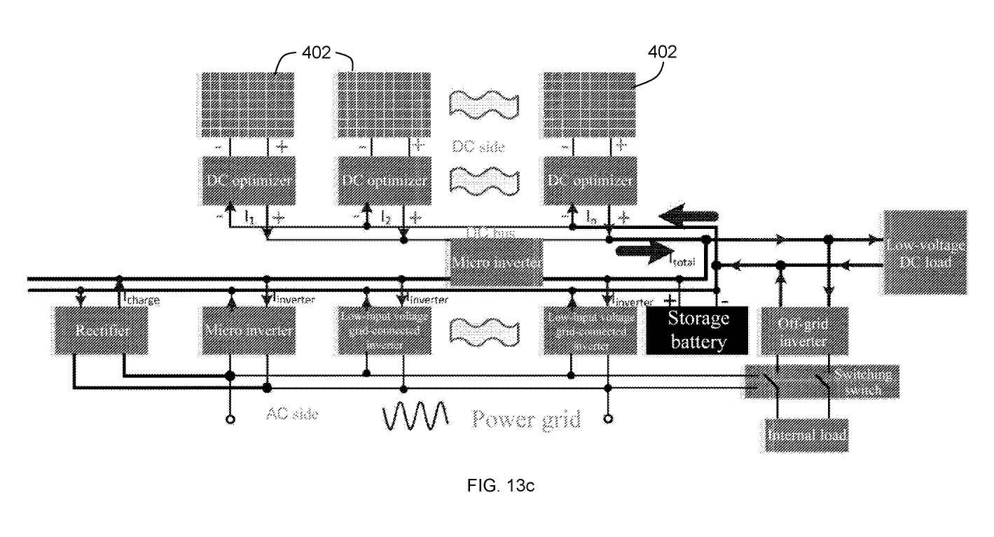

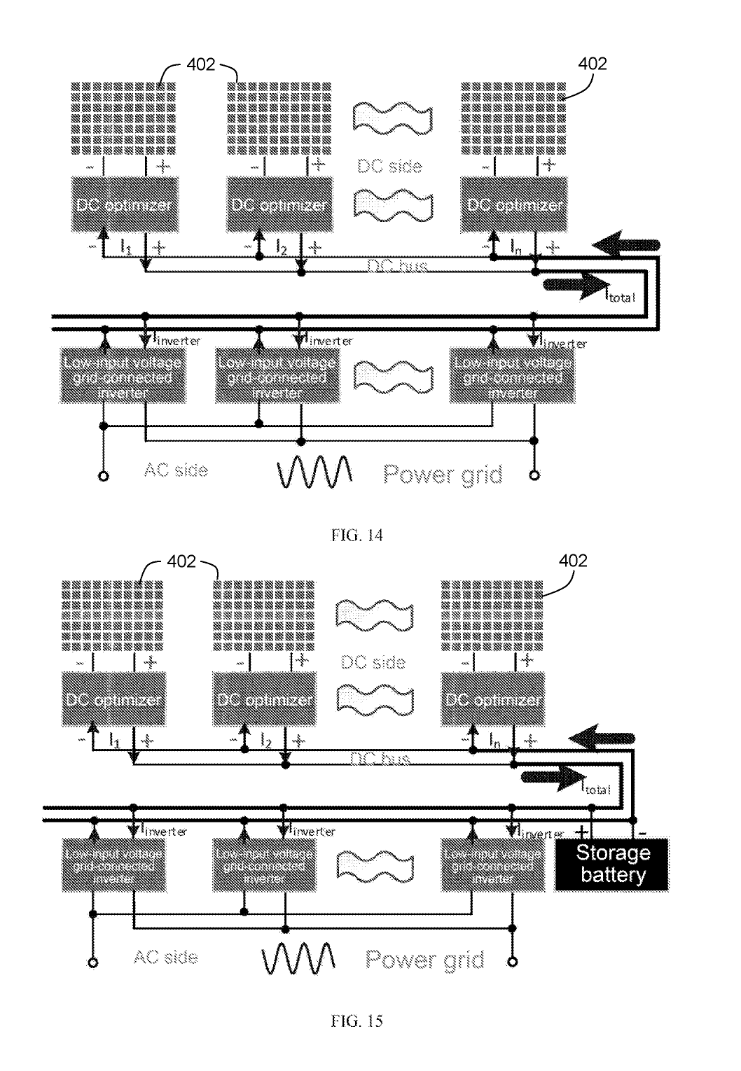

Further, because of the introduction of the storage battery, the solar power generation system proposed in the present disclosure can further add an off-grid solar inverter on the DC bus, so as to serve as a backup energy source for power supply when the power grid fails, as shown in FIG. 13a. The solar power generation system of FIG. 13a includes the off-grid inverter, a switching switch and an internal load. When the power grid fails, the switching switch is used to cut off the power supply of the power grid to the internal load, and only the off-grid inverter is used to supply power to the internal load, thereby achieving the function of emergency power supply. As illustrated in FIG. 13b (which includes all the elements of FIG. 13a), the DC bus can further supply energy for any adaptive low-voltage DC device, for the low-voltage DC device to run. As shown in FIG. 13c (which includes all the elements of FIG. 13b), to compensate for insufficient energy of the storage battery on the low-voltage DC bus, a rectifier for converting AC into low-voltage DC may be externally connected to the DC bus.

It can be seen from the above description that the solar power generation systems described in the present disclosure with respect to, e.g., FIGS. 4a-13c may be greatly advantageous in terms of reliability, power generation amount, and expandability as compared to other solar power generation systems, such as those of FIGS. 1-3. A potential downside of such solar power generation systems may be a slightly higher cost. The establishment cost of four 3 kW systems with one or more of the components (e.g., string formation type inverters, DC optimizers, micro inverters) described herein is used as an example for description. As shown in Table 1:

TABLE 1
Establishment cost of four 3 kW solar power generation systems

| | String | | | |
|---|---|---|---|---|
| | formation | DC optimizer + | | |
| | type | string formation | Micro | DC optimizer + |
| | inverter | type inverter | inverter | micro inverter |
| Solar panel | 750*12 | 750*12 | 750*12 | 750*12 |
| ( [symbol] ) | | | | |
| DC optimizer | 0 | 150*12 | 0 | 150*12 |
| ( [symbol] ) | | | | |
| Inverter ( [symbol] ) | 4000 | 4000 | 500*12 | 500*12 |
| High-voltage | 1000 | 1000 | 0 | 0 |
| protector ( [symbol] ) | | | | |
| Total price ( [symbol] ) | 14000 | 15800 | 15000 | 16800 |
| Warranty | 5 years | 5 years | 10 years | 10 years |

The increased cost of an embodiment of the solar power generation system proposed in the present disclosure compared with the cost of other solutions is not high. For example, the embodiment of FIG. 4b may correspond to the column in Table 1 labeled “DC optimizer+micro inverter”, which may be only about Y2800 than solution 1 (FIG. 1) that corresponds to the column in Table 1 labeled “String formation type inverter.” However, the improvements in the safety, reliability and expandability brought about by the low-voltage DC bus solution according to some embodiments are very apparent. Moreover, because of the self-current-sharing control and the redundancy control manners of the micro inverter, the number of the inverters may be reduced. According to actual experiences, the workable maximum power of a 250 W solar panel is merely 225 W, and in other words, the maximum DC bus power that can be provided by the 3 kW solar panel is merely 2.7 kW, and therefore, it is unnecessary to dispose twelve 250 W micro inverters, and eleven inverters are enough for the system. One more inverter may be added under the consideration of backup and redundancy control. Under the consideration of the establishment cost of the system, the additional inverter can be removed, thereby further reducing the establishment cost of the system.

Furthermore, the micro inverter may be replaced by a conventional low-input voltage grid-connected inverter. In other words, the solar power generation system is not limited to using the micro inverters, and after the low-voltage DC bus is constructed, the conventional low-input voltage grid-connected inverters may also be used to establish the solar power generation system, as shown in FIG. 14. The number of the low-input voltage grid-connected inverters may be adjusted properly according to the power of the solar panels of the system, thereby further reducing the cost of the system, so as to achieve low cost and high reliability. A single conventional low-input voltage grid-connected inverter with enough power may be used to establish the system, and inputs of multiple inverters may also be connected in parallel to establish the system together, as long as the low-input voltage grid-connected inverter conducts self-current-sharing control and redundancy control.

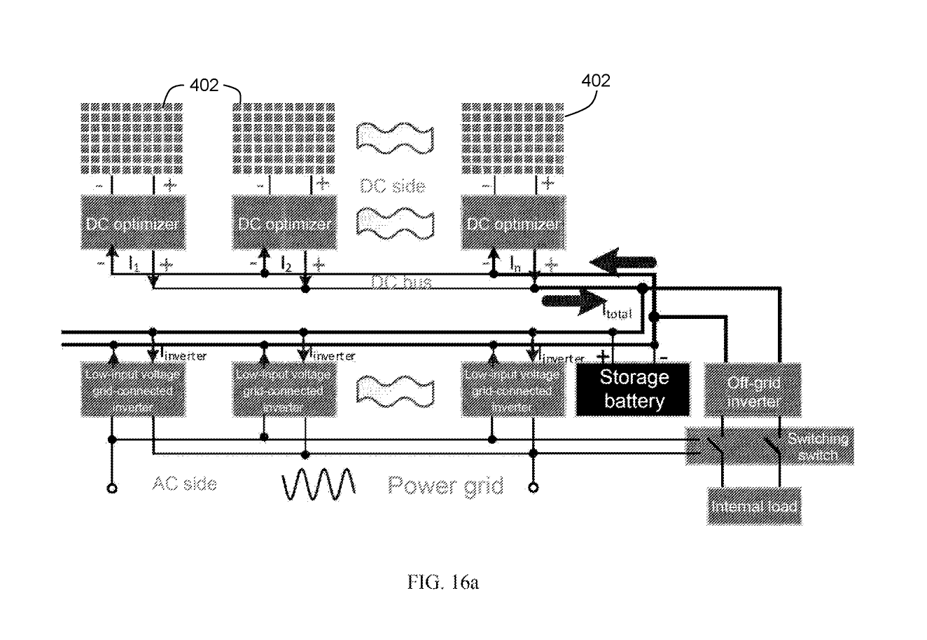

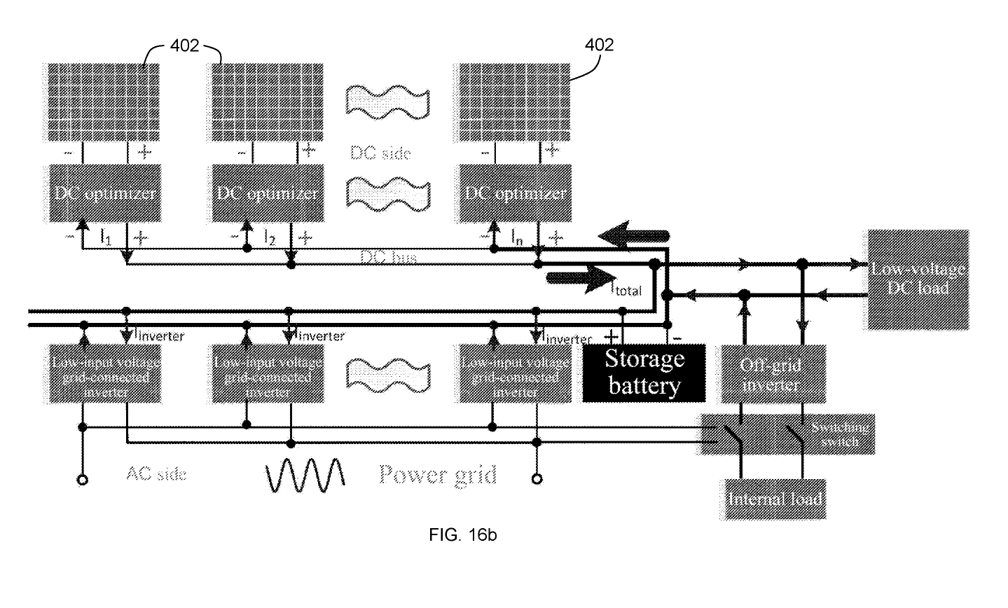

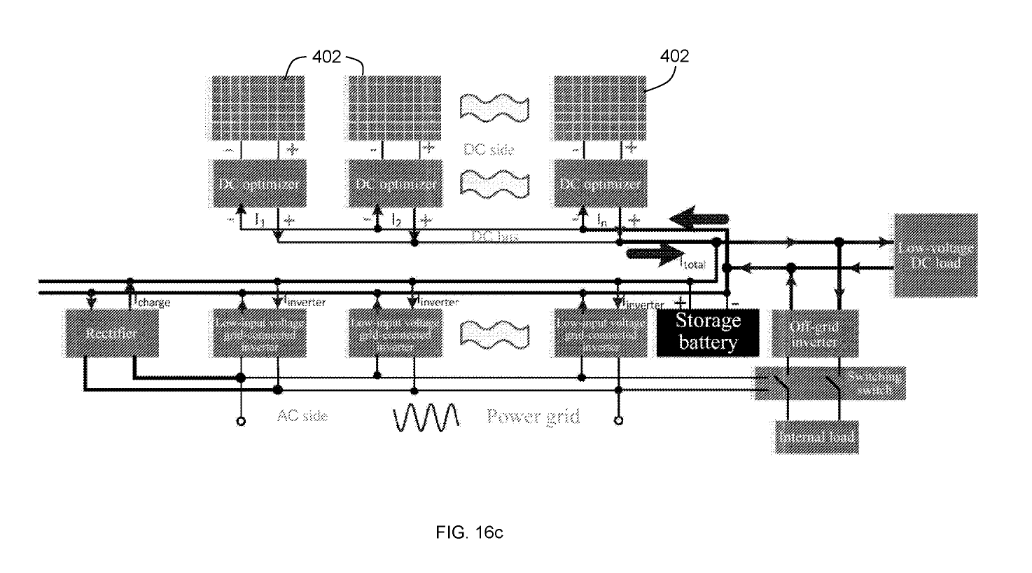

Correspondingly, as shown in FIG. 15, the solar power generation system constructed by using the low-input voltage grid-connected inverter may also have a storage battery directly added on the low-voltage DC bus for energy storage. As shown in FIG. 16a, an off-grid inverter may also be connected to the low-voltage DC bus, so that when the power grid fails, the off-grid system may be switched to supply backup power for the internal load that needs to be powered. As shown in FIG. 16b, the DC bus may supply energy for any adaptive low-voltage DC device for the low-voltage DC device to run. As shown in FIG. 16c, to compensate the insufficient energy of the storage battery on the low-voltage DC bus, a rectifier for converting AC into low-voltage DC is externally connected to the DC bus to charge the storage battery.

The low-input voltage grid-connected inverter may be single-path input, and may also be two-path or multi-path input.

In view of the above, the solar power generation systems disclosed in the present disclosure use a corresponding one of the DC optimizers to control each solar panel to work at the maximum power point, the DC optimizers have their outputs connected in parallel to construct the low-voltage DC bus, and the low-voltage DC electricity is converted into AC electricity by using one or more micro inverters or low-input voltage grid-connected inverters connected to the power grid for power generation. The low-voltage DC bus can also be directly connected to the low-voltage storage battery, so as to form the solar power generation system having an energy storage function. Moreover, the off-grid inverter may further be connected between the DC bus and an internal load to form the solar power generation system having the backup power supplying capability. To increase the life time of the whole solar power generation system, the present disclosure further proposes the self-current-sharing control and redundancy control solutions in terms of the control of the inverters. The self-current-sharing may balance the inverter loss, average the heat distribution, and prolong the service life of the system. The redundancy control may enable each inverter to work at the highest conversion efficiency point thereof, thereby reducing the energy loss of the system and improving the conversion efficiency of the whole system. Meanwhile, the redundancy control may optimize the energy flowing, and make a part of machines to be in a standby state. The random working point principle in the redundancy control causes that different inverters work for the longest time every day, thereby prolonging the service life of the inverter, and improving the reliability and stability of the whole system. The solar power generation system of the present disclosure does not increase much cost compared with the conventional solar power generation system, but brings very obvious improvements in terms of stability, reliability and extendibility.

The solar power generation system in the technical solution of the present disclosure may be single-phased, and may also be a three-phase power generation system having different voltage levels formed by single phases.

The technical solution of the present disclosure uses the micro inverter and the low-input voltage grid-connected inverter for specific descriptions; however, the technical solution of the present disclosure may also use other inverters for replacement, which is a common measure for persons skilled in the art, and the principles and technical measures thereof are the same, which will not be repeated herein.

The inverter in the technical solution of the present disclosure may also be a string formation type inverter.

In some embodiments, one or more of the solar panels 402 includes a plurality of photovoltaic (PV) cells electrically connected in series. For instance, each of the solar panels 402 may include 60 or 72 PV cells electrically connected in series.

Alternatively or additionally, one or more of the solar panels 402 may include three (or some other number) strings of PV cells where each string includes 20 or 24 (or some other number) PV cells electrically connected in series. In these and other embodiments, bypass diodes may be provided between the three strings so that one or more of the three strings may be bypassed in the event of a PV cell failure, poor lighting, debris blocking, or other problem with one or more of the PV cells in a corresponding one of the strings.

Alternatively or additionally, one or more of the solar panels 402 may include PV cells arranged in rows and columns where all of the PV cells in each row are electrically connected in parallel and the rows are electrically connected in series. Examples of such PV cell configurations are disclosed in U.S. Pat. Nos. 8,748,727, 8,933,320, 8,563,847 and 8,829,330, each of which is incorporated herein by reference in its entirety. In these and other embodiments, each of the solar panels 402 may include or be coupled to a charge controller or power conversion device instead of the DC optimizers described herein. Such charge controllers or power conversion devices may be configured to track maximum power point of a corresponding one of the solar panels and may stabilize its current. Alternatively or additionally, such charge controllers or power conversion devices may each include multiple power conversion circuits, each of which may include, e.g., a boost converter to collectively boost a solar panel output of less than or equal to about 20 volts DC to about 50 volts DC or more on the DC bus.

In comparison, in embodiments described herein, each DC optimizer may include one or more buck-boost converters and/or may receive a solar panel output from a corresponding one of the solar panels 402 at about 40-50 volts DC. Each DC optimizer may isolate the corresponding solar panel 402 from the rest of the system and/or may have an output of about 50 volts DC. In these and other embodiments, the DC optimizers may be provided separately from the solar panels 402 as the 40-50 volt DC output of each solar panel 402 can tolerate longer leads. In embodiments such as described in the '727, '320, '847, and '330 patents, the charge controller or power conversion device may instead be integrated with the corresponding solar panel due to the relatively high current (and relatively low voltage, e.g., about 20 volts DC or less) output of the solar panels, which would otherwise require relatively large (and therefore expensive) leads to tolerate the relatively high current if the charge controller or power conversion device were not integrated with the corresponding solar panel.

Finally, it should be noted that, all the above descriptions are merely preferred embodiments of the present invention, and are not intended to limit the present invention. The present invention has been described in detail with reference to the above embodiments; however, for persons skilled in the art, modifications can still be made to the technical solutions recorded in the embodiments, or equivalent replacements may be made for a part of the technical features. Any modification, equivalent replacement, improvement or the like made without departing from the spirit and principle of the present invention should fall within the scope of claims of the present invention.

What is claimed is:

1. A solar power generation system, comprising:
a plurality of solar panels;
a plurality of DC optimizers; and
a plurality of inverters, wherein:
a number of the plurality of solar panels includes N;
a number of the plurality of DC optimizers includes N;
a number of the plurality of inverters includes M;
an output of each of the plurality of solar panels is connected to a corresponding one of the plurality of DC optimizers;
each of the plurality of DC optimizers is configured to track maximum power point of a corresponding one of the plurality of solar panels and stabilize its current;
outputs of the plurality of DC optimizers are connected in parallel to construct a low-voltage DC bus;
inputs of the plurality of M inverters are connected in parallel to the DC bus;
the plurality of M inverters whose inputs are connected in parallel extract current from the DC bus; and
outputs of the plurality of inverters are connected in parallel to a power grid.

2. The solar power generation system of claim 1, wherein each of the plurality of DC optimizers: is integrated in a corresponding solar panel junction box or is connected to a corresponding one of the plurality of solar panels as an independent external device, integrates communication, and has an input power that is adjustable through remote communication.

3. The solar power generation system of claim 1, wherein each of the plurality of inverters is controlled by using self-current-sharing control and redundancy control in which:
in the self-current-sharing control, total output power that can be provided by the DC bus is Pmax, the M plurality of inverters are connected in parallel and extract current from the DC bus, and power processed by each inverter is Pinverter=Pmax/M; and
in the redundancy control:
a working point Vsetpoint of each inverter is set;
output currents of the N plurality of DC optimizers are added to start to charge the DC bus;
after the voltage of the DC bus is boosted to a working point of one of the plurality of inverters, the one of the plurality of inverters starts to convert energy and output power;
after there is energy flowing toward the power grid, the voltage of the DC bus is drawn down, and in this point, there are two cases:
one case is that the power provided by the plurality of DC optimizers is greater than the power that can be output by the one of the plurality of inverters, the voltage of the DC bus may be continuously boosted, and when the voltage reaches a working point of a second one of the plurality of inverters, the second one of the plurality of inverters starts to output power, that is, starts to extract the current of the DC bus, if the power of the DC bus is still greater than the sum of the output powers of the two inverters, a third one of the plurality of inverters starts to work, and the process repeats until the power provided by the DC bus is less than the power output by a working inverter, and in this case, the inverters working firstly work in the highest conversion efficiency condition, and the last inverter works at the proper power; and
the other case is that when the power provided by the DC bus is less than the power of the inverter, only one inverter works, and other inverters are in a standby state; the multiple inverters may be set to have the same working point, the multiple inverters having the same working point are set to work together, and when the multiple inverters having the same working point work together, the multiple inverters enable the self-current-sharing control.

4. The solar power generation system of claim 3, wherein the number of the inverters is M+1, that is, one more inverter is configured according to the case of full power.

5. The solar power generation system of claim 1, wherein the DC bus is electrically connected to a low-voltage DC device to provide energy for the low-voltage DC device to run.

6. The solar power generation system of claim 5, wherein the DC bus is connected to a storage battery, and each of the plurality of inverters is compatible with a management control strategy of the storage battery, specifically:
when the storage battery is run out, each of the plurality of DC optimizers tracks the maximum power of the corresponding one of the plurality of solar panels, and outputs power to the low-voltage DC bus, in this case, the battery level of the storage battery is low, the current on the DC bus preferentially charges the storage battery, until the voltage of the DC bus is boosted to the working voltage of the one of the plurality of inverters, the one of the plurality of inverters starts to work, the one of the plurality of inverters sends redundant power on the DC bus to the power grid, and when it is necessary to discharge the storage battery, the storage battery is discharged by adjusting the working voltage of the one of the plurality of inverters to be less than the output voltage of the storage battery, and the working voltage of the one of the plurality of inverters is greater than or equal to a safety voltage of the storage battery to protect the storage battery;
to compensate insufficient energy of the storage battery on the DC bus, a rectifier for converting AC into low-voltage DC is externally connected to the DC bus between the DC bus and the power grid, and the rectifier is configured to convert AC into low-voltage DC output to the DC bus to charge the storage battery when the energy on the DC bus is otherwise insufficient.

7. The solar power generation system of claim 6, further comprising an off-grid inverter and a switching switch, wherein when the power grid fails, the switching switch is used to cut off the power supply of the power grid to an internal load, and only the off-grid inverter is used to supply power to the internal load.

8. The solar power generation system of claim 1, wherein the number M of the plurality of inverters is any number between 1 and N, and a ratio of DC power to AC power is adjusted according to a ratio of M and N.

9. The solar power generation system of claim 1, wherein each of the plurality of solar panels comprises a polycrystalline solar panel, a monocrystalline solar panel, or a thin-film solar panel.

10. The solar power generation system of claim 1, wherein:
each of the plurality of inverters comprises a micro inverter or a low-input voltage grid-connected inverter; and
each of the plurality of inverters has single-path input, two-path input or multi-path input.

11. The solar power generation system of claim 1, wherein one or more of the plurality of solar panels includes three strings of 20 or 24 serially-connected photovoltaic cells.

12. The solar power generation system of claim 1, wherein one or more of the plurality of solar panels includes 60 or 72 serially-connected photovoltaic cells.
